(19) United States
(12) Patent Application Publication
(10) Pub. No.: US 2019/0291949 A1
(43) Pub. Date: Sep. 26, 2019

(54) Bag tightening trash can

(71) Applicant: Matthew Ross, North Port, FL (US)

(72) Inventor: Matthew Ross, North Port, FL (US)

(21) Appl. No.: 15/927,432

(22) Filed: Mar. 21, 2018

(51) Int. Cl. B65F 1/06

(52) U.S. Cl. CPC B65F 1/06; B65F 2210/179

(57) ABSTRACT

The invention is directed to a bag tightening trash can. Upon placing a fresh trash bag in the trash can, the user may press a button on the side surface, which activates a battery-powered suction fan in the bottom of the trash can for a short, predetermined period, such as 5 seconds. The suction fan gently draws the sides of the trash bag outward, tightening it against the interior surfaces of the trash can and fully expanding it. A simple grate separates the trash bag from the suction fan, which expels air through a vent at the lower end of the rear surface. The suction fan automatically shuts off to conserve battery power. All of the internal components are preferably waterproof and easily cleaned.

### CROSS-REFERENCE TO RELATED APPLICATIONS

This application relates back to, and claims the priority of Provisional Patent Application No. 62482668 filed on Apr. 6, 2017.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to janitorial tools and equipment, and in particular to a bag tightening trash can. In schools and other large buildings, the janitorial staff invests a great deal of time and effort removing full trash bags from trash cans and replacing them with empty trash bags. The trash bags are provided flat, usually on a roll, and opening them such that they can be placed in a trash can is times consuming and annoying.

A search of the prior art reveals various devices which have been developed to provide the features of a trash can, which is capable of opening and deploying a trash bag quickly and easily, in a single device. None are closely related to the present invention, but several include features which resemble those of the present invention. Each has proven to be less than satisfactory for the present purpose in its own way.

Waste can with bag dispenser and removable liner, U.S. Pat. No. 5,704,511 (priority May 9, 1996), provides a trash receptacle that has an outer frame and a hinged lid. At the bottom of the outer frame is a housing designed to hold a large roll of plastic trash bags. The bottom of the housing is fitted with a space to accommodate the lid-lifting mechanism. At the top of the bag housing is a platform that supports a removable inner lining. The lower part of the lining is a rectangular box with a solid bottom and an open top. On top of this box is another rectangular box that has an open top and an open bottom. The top box is designed to interlock with the lower box. New bags are dispensed from the roll through a slot in the back of the frame. A new bag is torn off and the supply of bags remains in this slot ready for the next replacement. Two sets of bag holders hold the new bag in place.

Trash bag holder, U.S. Pat. No. 3,261,545 (priority Mar. 25, 1964), provides a cuffed bag and a holder within which a cuffed bag is placed with its cuff removably clamped over the top edges of the holder, to hold the bag in n open position, the bag being provided with a cover pivotally hinged to close over the cuffed open top of the bag. In addition, the holder is provided with a door opening in one side, through which the bag, after being unclamped from the top end may be readily removed. To facilitate removal of the bag, the bottom of the holder is progressively larger than the upper parts, so that the bag will be easily removed therefrom, even though its bottom may become somewhat bulged from the load placed therein.

Trash can liner with bag securing mechanism, U.S. Pat. No. 7,694,838 (priority Sep. 14, 2004), provides a liner for use in a trash can, comprised of a body having a surrounding wall and a top edge that defines a mouth, and a trash bag securing mechanism provided on the body adjacent the top edge. A user can insert a trash bag into the liner, open the mouth of the trash bag and then secure a portion of the trash bag to the trash bag securing mechanism.

Bag support device for supporting a bag within a trash container, U.S. Pat. No. 5,222,704 (priority Jun. 3, 1992), provides a bag support device for supporting a plastic bag within a trash container. The device includes a pair of elongated clamp arms structured and disposed to apply a clamping force on opposite sides of a wall of the container, and a hook member extending upwardly from a lower end of one of the clamp arms within the container. The hook member is structured and disposed to support a portion of a handle of a plastic bag placed within the container, wherein at least two of the support devices attached to opposite side walls of the container support opposite handles of the bag such that an open end thereof is held open such that items may be deposited therein.

Trash bag holding and spreading device, U.S. Pat. No. 5,088,667 (priority Jul. 26, 1990), provides a unitary one-piece holder for removably retaining and spreading open a trash bag. The holder includes a pair of retainer halves, each of which has a respective internal face, first adjoining edge that adjoin one another and second remote edge. The halves are joined together along the respective adjoining edges thereof by at least one hinge. The halves are pivotable about the hinge in a first closed direction and in a second open direction. In the first direction, the remote edges and the internal faces are moved toward one another for closing the device with a “snap-action” and clamping at least a portion of the bag therebetween, so that the bag is at least partially spread open. In the second direction, the remote edges and the internal faces are moved away from one another for opening the device and unclamping and releasing the trash bag from therebetween. Means are provided carried by the halves for removably securing the retainer halvew to one another for removably closing the device with the “snap-action” when the halves are moved in the first direction.

Some of the prior art inventions present certain disadvantages. The present invention has been developed for the purpose of addressing and resolving these disadvantages. A device that enables the user to quickly and easily insert a fresh trash bag in a trash can and, with the push of a button, deploy the trash bag to its full volume would be well received. A bag tightening trash can, which uses air suction to fully deploy a fresh trash bag, would resolve this problem.

### SUMMARY OF THE INVENTION

Accordingly, the invention is directed to a bag tightening trash can. Upon placing a fresh trash bag in the trash can, the user may press a button on the side surface, which activates a battery-powered suction fan in the bottom of the trash can for a short, predetermined period, such as 5 seconds. The suction fan gently draws the sides of the trash bag outward, tightening it against the interior surfaces of the trash can and fully expanding it. A simple grate separates the trash bag from the suction fan, which expels air through a vent at the lower end of the rear surface. The suction fan automatically shuts off to conserve battery power. All of the internal components are preferably waterproof and easily cleaned.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification. They illustrate one embodiment of the invention and, together with the description, serve to explain the principles of the invention.

FIG. 1 is a side view of the first exemplary embodiment, displaying the trash can 10, the button 11, and the vent 16.

FIG. 2 is a side perspective view of the first exemplary embodiment, displaying the trash can 10, the button 11, and the vent 16.

FIG. 3 is a top perspective view of the first exemplary embodiment, displaying the trash can 10, and the grate 15.

FIG. 4 is a top perspective view of the first exemplary embodiment with the grate removed, displaying the trash can 10, the suction fan 12, the battery packs 13, and the wires 14.

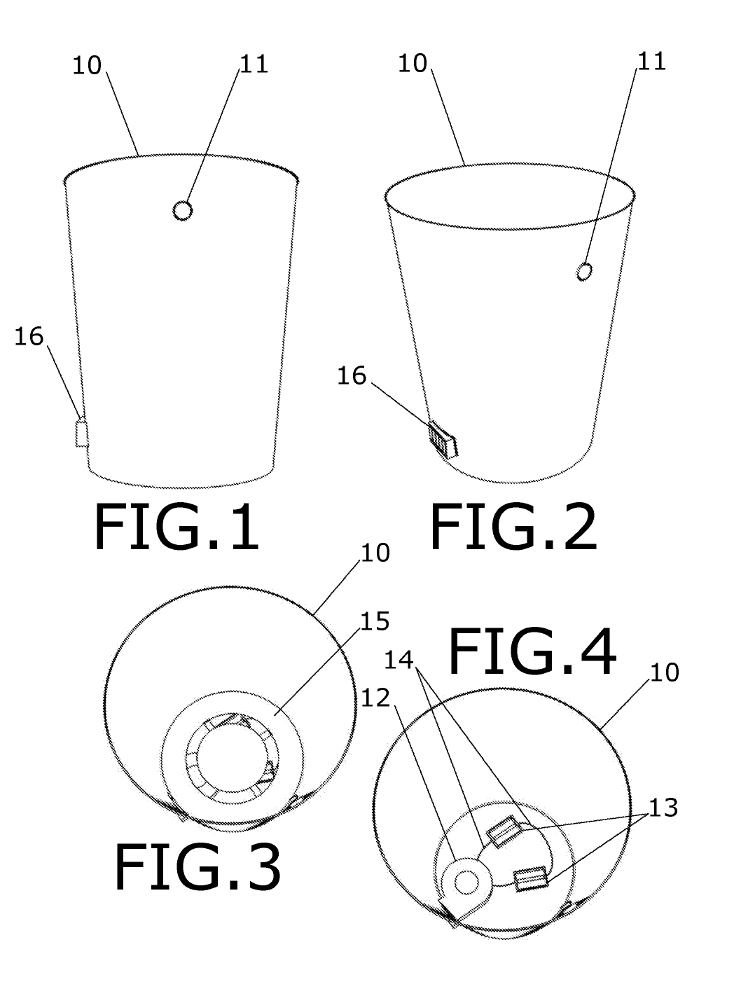

### DETAILED DESCRIPTION OF THE INVENTION

Referring now to the invention in more detail, the invention is a bag tightening trash can 10.

It is to be understood that while the invention is intended for use by commercial janitorial services and in commercial buildings, this is not intended as a limitation. With suitable modifications or with no modifications at all, the invention may be used in residential applications, and may be particularly useful in the homes of elderly or disabled persons.

The first exemplary embodiment is comprised of a trash can 10, providing a button 11 on the side surface. Upon placing a fresh trash bag in the trash can 10, the user may press the button 11, which activates a battery-powered suction fan 12 in the bottom of the trash can 10 for a short, predetermined period, such as 5 seconds.

The suction fan 12 gently draws the sides of the trash bag outward, tightening it against the interior surfaces of the trash can 10 and fully expanding it. A simple grate 15 separates the trash bag from the suction fan 12, which expels air through a vent 16 at the lower end of the side surface. The suction fan 12 automatically shuts off to conserve battery power. Preferably, two battery packs 13 are provided on the bottom of the trash can 10, each requiring two standard AA batteries. More or fewer batteries and battery packs 13 are contemplated. The battery packs 13 and the button 11 are connected to the suction fan 12 via wires 14.

Due to the practice of dropping partially consumed soft drinks in trash cans, the internal components of the trash can 10 are preferably waterproof and easily cleaned. The trash can 10 is preferably provided in a broad variety of sizes and styles. By using the invention, a worker for a commercial janitorial service can reduce the amount of time necessary to install a new trash bag to as little as five seconds. An upper ring on the rim, with or without a latch and hinges, may be provided on the trash can 10 to help secure the trash bag to the rim.

To use the first exemplary embodiment, the user may insert a fresh trash bag into the trash can 10, secure the upper edge of the trash bag around the rim of the trash can 10, and press the button 11. Further operation is automatic.

The trash can 10, the button 11, the suction fan 12, the battery packs 13, the grate 15, and the vent 16 are preferably manufactured from rigid, durable materials that are easily cleaned, such as stainless steel, aluminum alloy, and plastic. The wires 14 are preferably manufactured from braided copper alloy wire sheathed in plastic.

Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A trash can, providing a button on the side surface, such that upon placing a fresh trash bag in the trash can, the user may press the button, which activates a battery-powered suction fan in the bottom of the trash can for a short, predetermined period, such as 5 seconds; the suction fan gently draws the sides of the trash bag outward, tightening it against the interior surfaces of the trash can and fully expanding it.

2. The trash can of claim 1, wherein a simple grate separates the trash bag from the suction fan, which expels air through a vent at the lower end of the side surface of the trash can.

3. The trash can of claim 1, wherein the suction fan automatically shuts off to conserve battery power.

4. The trash can of claim 1, wherein a plurality of battery packs are provided on the bottom surface of the trash can, connected to the button and the suction fan via wires.

5. The trash can of claim 1, wherein the internal components of the trash can are preferably waterproof and easily cleaned.

6. The trash can of claim 1, wherein an upper ring on the rim, with or without a latch and hinges, may be provided on the trash can to help secure the trash bag to the rim.

7. The trash can of claim 1, wherein the trash can, the button, the suction fan, the battery packs, the grate, and the vent are preferably manufactured from rigid, durable materials that are easily cleaned, such as stainless steel, aluminum alloy, and plastic.
